(19) United States
(12) Patent Application Publication
(10) Pub. No.: US 2008/0179247 A1
(43) Pub. Date: Jul. 31, 2008

(54) Elimination of Wastewater Treatment System

(75) Inventor: Bruce Roger DeBruin, Lexington, SC (US)

Correspondence Address: STEVEN A. OWEN;EASTMAN CHEMICAL COMPANY, P.O. BOX 511, KINGSPORT, TN, 37662, US

(73) Assignee: EASTMAN CHEMICAL COMPANY, Kingsport, TN (US)

(21) Appl. No.: 11/934,271

(22) Filed: Nov. 2, 2007

Related U.S. Application Data
(60) Provisional application No. 60/898,327, filed on Jan. 30, 2007.

(51) Int. Cl. C02F 1/02; C02F 1/12

(52) U.S. Cl. 210/640; 210/180

(57) ABSTRACT

A method reducing wastewater in a polyester-manufacturing plant includes a step in which ethylene glycol-containing composition from at least one of the chemical reactors is provided to a water separation column. The water separation column is kept within a predetermined temperature range such that any acetaldehyde present in the water separation column is substantially maintained in a vapor state. A waste-vapor mixture comprising one or more organic compounds is subsequently removed from the water separation column and combusted. The polyester-manufacturing plant optionally includes a spray condenser system having a heat exchanger such that the heat exchanger is contacted with a hot ethylene glycol composition derived from the water separation column when the heat exchanger needs cleaning. The polyester-manufacturing plant may be enclosed with a roof and walls such that rainwater is prevented from being contaminated with any organic chemicals present in the polyester-manufacturing plant.

### CROSS-REFERENCE TO RELATED APPLICATIONS

This application claims priority to U.S. Provisional Application Ser. No. 60/898,327, filed on Jan. 30, 2007, the disclosure of which is incorporated herein by reference in its entirety

### FIELD OF THE INVENTION

The present invention relates generally to methods and systems for reducing wastewater in a chemical plant and, in particular, to methods and systems for reducing wastewater in a polyester forming plant.

### BACKGROUND OF THE INVENTION

Polyester is a widely used polymeric resin used in a number of packaging and fiber-based applications. Poly(ethylene terephthalate) (“PET”) or a modified PET is the polymer of choice for making beverage and food containers such as plastic bottles and jars used for carbonated beverages, water, juices, foods, detergents, cosmetics, and other products. These containers are manufactured by a process that typically comprises drying the PET resin, injection molding a preform and, finally, stretch blow molding the finished bottle. Despite the stringent matrix of properties required for such uses, particularly for food packaging, PET has become a commodity polymer. PET is also used in a number of film and fiber applications. Commercial production of PET is energy intensive and, therefore, even relatively small improvements in energy consumption are of considerable commercial value.

In the typical polyester forming polycondensation reaction, a diol such as ethylene glycol is reacted with a dicarboxylic acid or a dicarboxylic acid ester. In the production of PET, terephthalic acid is usually slurried in ethylene glycol, and heated to produce a mixture of oligomers of a low degree of polymerization. The reaction is accelerated by the addition of a suitable reaction catalyst. Since the product of these condensation reaction tends to be reversible, and in order to increase the molecular weight of the polyesters, this reaction is often carried out in a multi-chamber polycondensation reaction system having several reaction chambers operating in series. Typically, the diol and the dicarboxylic acid component are introduced in the first reactor at a relatively high pressure. After polymerizing at an elevated temperature the resulting polymer is then transferred to the second reaction chamber which is operated at a lower pressure than the first chamber. The polymer continues to grow in this second chamber with volatile compounds being removed. This process is repeated successively for each reactor, each of which are operated at lower and lower pressures. The result of this step-wise condensation is the formation of polyester with high molecular weight and higher inherent viscosity. During this polycondensation process, various additives such as colorants and UV inhibitors may be also added. Polycondensation occurs at relatively high temperature, generally in the range of 270-305° C., under vacuum with water and ethylene glycol produced by the condensation being removed. The heat for the polycondensation reactions are typically supplied by one or more furnaces, such as heat transfer medium furnace (“HTM furnace”). Moreover, during the polycondensation process, a number of chemical waste byproducts are formed that need to be appropriately treated in order to meet government regulations. Among the waste byproducts formed in the typical PET process are acetic acid, various acid aldehydes, p-dioxane, 1,3 methyl dioxolane, and unreacted ethylene glycol.

With reference to FIG. 1, diagrams of prior art PET manufacturing facilities are provided. Polyester-manufacturing plant 10 includes polymer-manufacturing section 12 and waste treatment section 14. Polymer-manufacturing section 12 includes mixing tank 20 in which terephthalic acid (“TPA”) and ethylene glycol (“EG”) are mixed to form a pre-polymeric paste. This pre-polymeric paste is transferred and heated in esterification reactor 22 to form an esterified monomer. The pressure within esterification reactor 22 is adjusted to control the boiling point of the ethylene glycol and help move the products to esterification reactor 24. The monomer from esterification reactor 22 is subjected to additional heating in esterification reactor 24 but this time under less pressure than in esterification reactor 22. Next, the monomers from esterification reactor 24 are introduced into pre-polymer reactor 26. The monomers are heated within pre-polymer reactor 26 under a vacuum to form a pre-polymer. The inherent viscosity of the pre-polymer begins to increase within pre-polymer reactor 26. The pre-polymer formed in pre-polymer reactor 26 is sequentially introduced into polycondensation reactor 28 and then polycondensation reactor 30. The pre-polymer is heated in each of polycondensation reactors 28, 30 under a larger vacuum than in pre-polymer reactor 26 so that the polymer chain length and the inherent viscosity are increased. After the final polycondensation reactor, the PET polymer is moved under pressure by pump 32 through one or more filters and then through die(s) 34, forming PET strand(s) 36, which are cut into pellets 38 by cutter(s) 40. After crystallization, pellets 38 are transported to one or more pellet processing stations.

Still referring to FIG. 1, polyester-manufacturing plant 10 also includes waste treatment section 14. Spent vapor and liquids from one or more stages of polymer-manufacturing section 12 are directed into water column system 48. Water column system 48 includes water column 50, inlet conduits 52, 54 and condenser 56. Spent vapors are introduced into water column 50 via inlet conduit 52 while spent liquids are introduced via inlet conduit 54. Water column vapors emerge from a region near the top of water column 50 (i.e., the head) passing through condenser 56. Condensable vapors are condensed in condenser 56 and directed into reflux drum 58. Pump 60 is used to pump liquid out of reflux drum 56. The wastewater is an aqueous mixture that includes water and ethylene glycol. Prior art polyester forming plants often include a water separation column that receives ethylene glycol waste from paste tank and esterficiation reactors. It is observed that effluent removed from head 64 of waster column 62 often contain acetaldehyde, p-dioxane, and other organic components. The removal of p-dioxane is a particularly difficult problem since p-dioxane cannot be treated by any conventional wastewater treatment process. Instead, the p-dioxane must be removed and burned. Unfortunately, the liquids collected from the reflux drum 56 cannot be directly sent to a wastewater facility because of the paradioxane contamination.

The condensate from the reflux drum 56 is directed into stripper column 62. Steam is removed from the stripper column 62 via conduit 64. Steam can be added in addition to or instead of reboiler 80. Condensate from reflux drum 56 may also be directed back into water column 50 if desired. Stripper column 62 separates paradioxane out at the top of stripper column 62 which cannot be sent to a wastewater treatment facility. In stripper column 62, the paradioxane is combined with water (i.e. the steam) to form an azeotrope that is then sent to furnace 64 or to an oxidizer with other vapor components (e.g., steam, acetaldehyde). The fluids from the bottom of stripper column 62 which include water, ethylene glycol, and other organics are sent to a wastewater treatment facility. Maintenance of such wastewater treatment facilities represents a large expense not directly related for polymer formation. Reboiler 70 and pump 72 are also associated with water column 50. Pump 72 is used to provide reclaimed ethylene glycol to various users via conduit 74. Similarly, reboiler 80 and pump 82 are associated with stripper column 62. Stripper column 62 is used to direct the fluids from the bottom of stripper column 62.

Source waste liquids that are sent to water column 50 are derived from spray condenser systems 90, 92, 94. Spray condensers 90, 92, 94 are used to liquefy condensable vapors from pre-polymer reactor 26, polycondensation reactor 28, and polycondensation reactor 30. Solid deposits form within these heat exchangers necessitating period cleaning. Typically, the heat exchangers are cleaned with water thereby creating a water organic mixture that needs to be also sent to the wastewater treatment facility.

Finally, it should also be appreciated that rainwater containing the components of a typically polyester-manufacturing plant also provides a source of contaminated water needing processing in the wastewater treatment facility.

Although the prior art method and systems for making polymeric pellets and, in particular, polyester pellets work well, the equipment tends to be expensive to fabricate and to maintain. Such expenses in part are from the waste-water treatment equipment which alone may easily exceed a million dollars.

Accordingly, there exists a need for polymer processing equipment and methodology that is less expensive to install, operate, and maintain.

### SUMMARY OF THE INVENTION

The present invention overcomes one or more problems of the prior art by providing in at least one embodiment a method of reducing wastewater in a polyester-manufacturing plant that includes one or more chemical reactors and a water separation column in fluid communication with the one or more chemical reactors. The method of this embodiment comprises providing an ethylene glycol-containing composition from at least one of the chemical reactors to the water separation column. In a variation the ethylene glycol-containing composition comprises ethylene glycol and water. The water separation column separates a portion of the ethylene glycol from the ethylene glycol-containing composition. Advantageously, the water separation column is kept within a predetermined temperature range such that any acetaldehyde present in the water separation column is substantially maintained in a vapor state. A waste-vapor mixture comprising one or more organic compounds is subsequently removed from the water separation column. Finally, the waste-vapor mixture is combusted. In a variation of this embodiment, the polyester-manufacturing plant further includes a spray condenser system having a heat exchanger such that the heat exchanger is contacted with a hot ethylene glycol composition when the heat exchanger needs cleaning. In a further variation, the polyester-manufacturing plant is enclosed with a roof and walls such that rainwater is prevented from being contaminated with any organic chemical present in the polyester-manufacturing plant. Individually, each of the wastewater reducing aspects of the present embodiment allows a reduction in the costs of operating a wastewater treatment facility. When all three of the methods of reducing wastewater are combined in a single polyester-manufacturing plant, a wasterwater treatment facility may be completely avoided.

In another embodiment of the present invention, a polyester-manufacturing plant with reduced wastewater emission is provided. The polyester-manufacturing plant implements one or more of the methods set forth above. The plant of this embodiment includes a polymer-forming section and a waste treatment section. The polymer-forming section has one or more chemical reactors. The waste treatment section receives ethylene glycol containing fluids from the polymer-forming section. The waste treatment section has a water separation column that is maintained within a predetermined temperature range such that any acetaldehyde in the water separation column is maintained substantially in a vapor state. The polyester-manufacturing plant of the present embodiment includes a combustion device in fluid communication with the water separation column.

Additional advantages and embodiments of the invention will be obvious from the description, or may be learned by practice of the invention. Further advantages of the invention will also be realized and attained by means of the elements and combinations particularly pointed out in the appended claims. Thus, it is to be understood that both the foregoing general description and the following detailed description are exemplary and explanatory of certain embodiments of the invention and are not restrictive of the invention as claimed.

### BRIEF DESCRIPTION OF THE DRAWINGS

FIG. 1 is a schematic illustration of a prior art polyester-manufacturing plant with a polymer-manufacturing section and a waste treatment section;

FIG. 2 is a schematic illustration of a polyester-manufacturing plant implementing the wastewater-reducing methods of embodiments of the present invention;

FIG. 3 is a schematic illustration of a spray condenser in communication with the reactors of a variation of the present invention; and

FIG. 4 is a schematic illustration illustrating the cleaning of a spray condenser.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

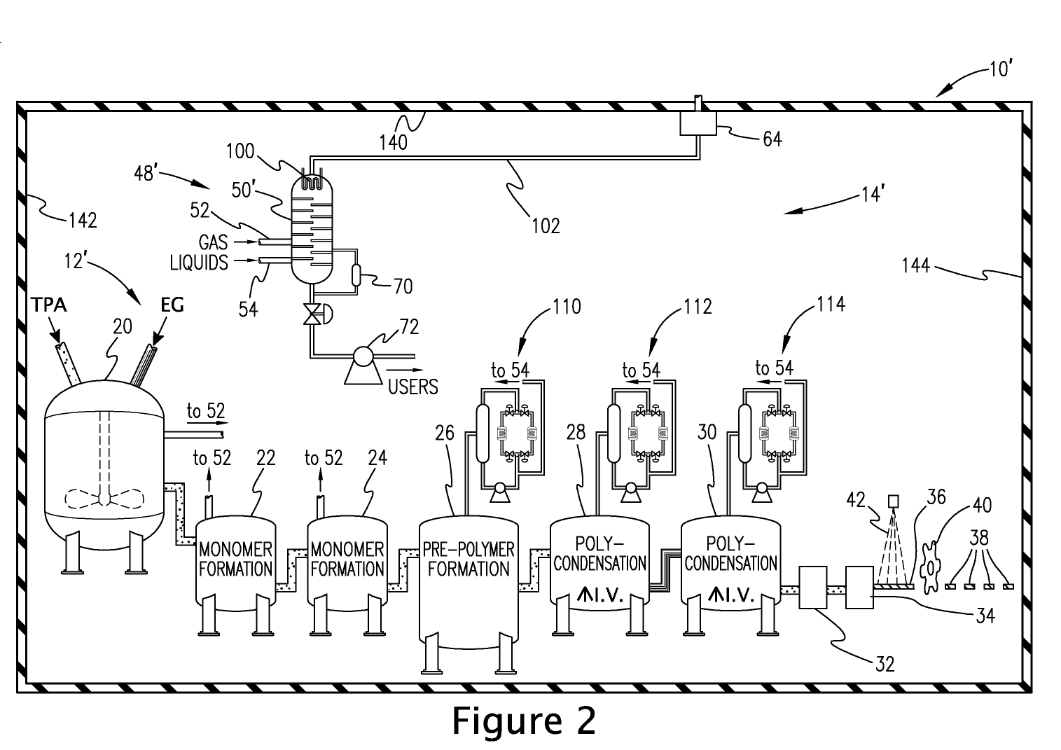

In an embodiment of the present invention, a method for reducing wastewater in a polyester-manufacturing plant that uses ethylene glycol is provided. With reference to FIG. 2, a schematic illustration of such a polyester-manufacturing plant is provided. The polyester-manufacturing plant depicted in FIG. 2 is a PET-manufacturing plant. Polyester-manufacturing plant 10′ includes polymer-forming section 12′ and waste treatment section 14′. Polymer-forming section 12′ includes one or more chemical reactors that emit various reaction by-products including un-reacted ingredients. Spent liquids and gases from polyester-forming section 14′ are processed by waste treatment section 14′. In particular, the spent liquids and gases from polyester-forming section 14′ are ethylene glycol-containing compositions. Waste treatment sections will generally recycle some chemical and convert other waste compounds to a safe form.

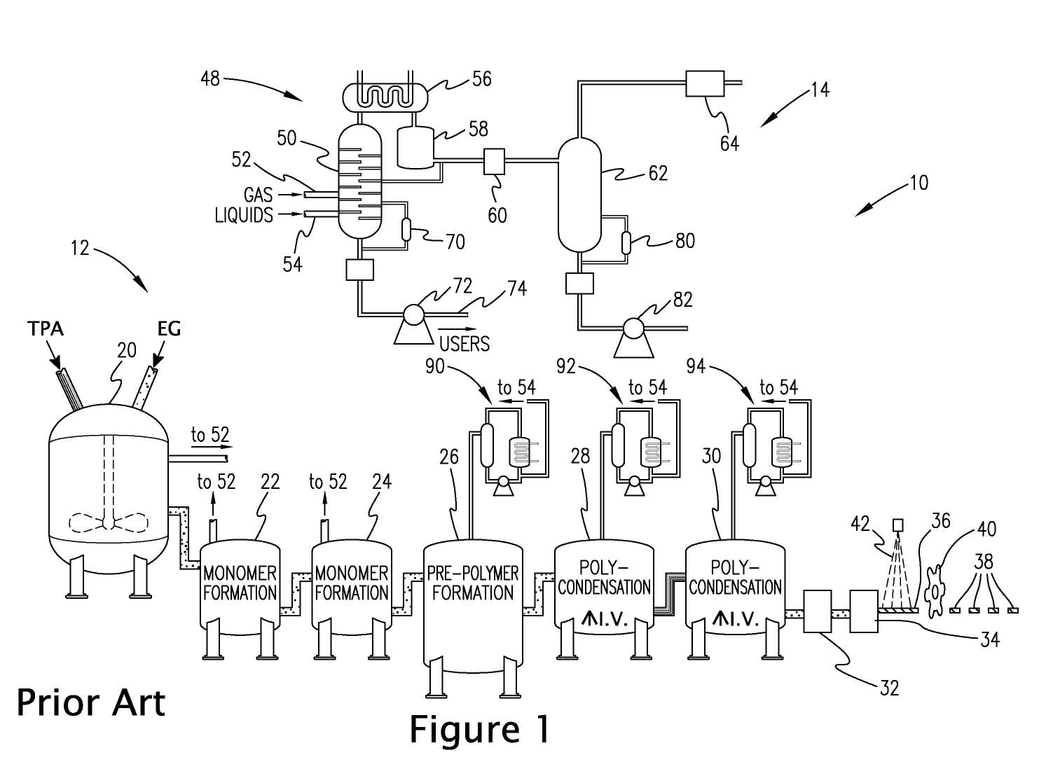

The general configuration of polymer-forming section 12′ is similar to the prior art section set forth above in connection with the description of FIG. 1. Polymer-forming section 12′ includes mixing tank 20 in which terephthalic acid (“TPA”) and ethylene glycol (“EG”) are mixed to form a pre-polymeric paste. This pre-polymeric paste is transferred and heated in esterification reactor 22 to form an esterified monomer. The pressure within esterification reactor 22 is adjusted to control the boiling point of the ethylene glycol and help move the products to esterification reactor 24. The monomer from esterification reactor 22 is subjected to additional heating in esterification reactor 24 but this time under less pressure than in esterification reactor 22. Next, the monomers from esterification reactor 24 are introduced into pre-polymer reactor 26. The monomers are heated within pre-polymer reactor 26 under a vacuum to form a pre-polymer. The inherent viscosity of the pre-polymer begins to increase within pre-polymer reactor 26. The pre-polymer formed in pre-polymer reactor 26 is sequentially introduced into polycondensation reactor 28 and then polycondensation reactor 30. The pre-polymer is heated in each of polycondensation reactors 28, 30 under a larger vacuum than in pre-polymer reactor 26 so that the polymer chain length and the inherent viscosity are increased. After the final polycondensation reactor, the PET polymer is moved under pressure by pump 32 through one or more filters and then through die(s) 34, forming PET strand(s) 36, which are cut into pellets 38 by cutter(s) 40.

Still referring to FIG. 2, polyester-manufacturing plant 10′ also includes waste treatment section 14′. Spent vapor and liquids from one or more stages of polymer-forming section 12′ are directed into water column system 48′. In the present embodiment, water column system 48′ includes water column 50′, inlet conduits 52, 54 and condenser 100. Spent vapors are introduced into water column 50′ via inlet conduit 52 while spent liquids are introduced via inlet conduit 54. In a variation of the present embodiment, water column system 48′ is maintained at a temperature range such that acetaldehyde, if present, is maintained in a gaseous state. Typically, separation column 50′ is maintained at a temperature from about 90° C. to about 220° C. It has been surprisingly found that the formation of p-dioxane is reduced by maintaining water column system with a concurrent reduction of p-dioxane in the head removed from water separation column 50′ being reduced. In some variations of the present invention, water column system 48′ separates at least a portion of the ethylene glycol from the water. Water separation column system 48′ is kept at a sufficient temperature so that any acetaldehyde present in the column is maintained substantially in a vapor state. In one variation, the temperature requirements of the present invention are achieved by placement of condenser 100 within or directly proximate to water separation column 50′. In the arrangement of this variation, a waste-vapor mixture is subsequently removed from water separation column 50′ via conduit 102. The waste vapor mixture includes water and one or more organic compounds from the separation column. The waste vapor mixture is then combusted in combustion device 64.

As set forth above, the waste vapor mixture includes one or more organic compounds. In one variation of this embodiment, the waste vapor mixture comprises an organic component selected from the group consisting of ethylene glycol, acetaldehyde, p-dioxane, and combinations thereof. It should be appreciated that ethylene glycol is typically present because ethylene glycol is present in the wastewater composition introduced into water separation column 50′. In some instances, the ethylene glycol is transformed into one or more of the other organic compounds that are present in the waste vapor mixture. For example, at various temperatures and pressures acetaldehyde and p-dioxane are each formed from the ethylene glycol.

Water separation column 50′ is maintained at a sufficient temperature so that any acetaldehyde present in the column is substantially in a vapor state. To this end, in one variation of the present embodiment, separation column 50′ is maintained at a temperature from about 60° F. to about 150° F. In one refinement, the waste vapor mixture is removed from water separation column 50′ at a temperature from 80° F. to 130° F.

In a further refinement of the present invention, the waste vapor mixture is combusted in combustion device 64 utilizing a fuel as a combustion source. Advantageously, the waste vapor mixture is combined with the fuel prior to being combusted. Typically, the fuel is introduced into combustion device 64 at a temperature from 100° F. to 130° F. In still a further refinement of the present invention, the fuel is introduced into combustion device 64 at a temperature from 110° F. to 130° F.

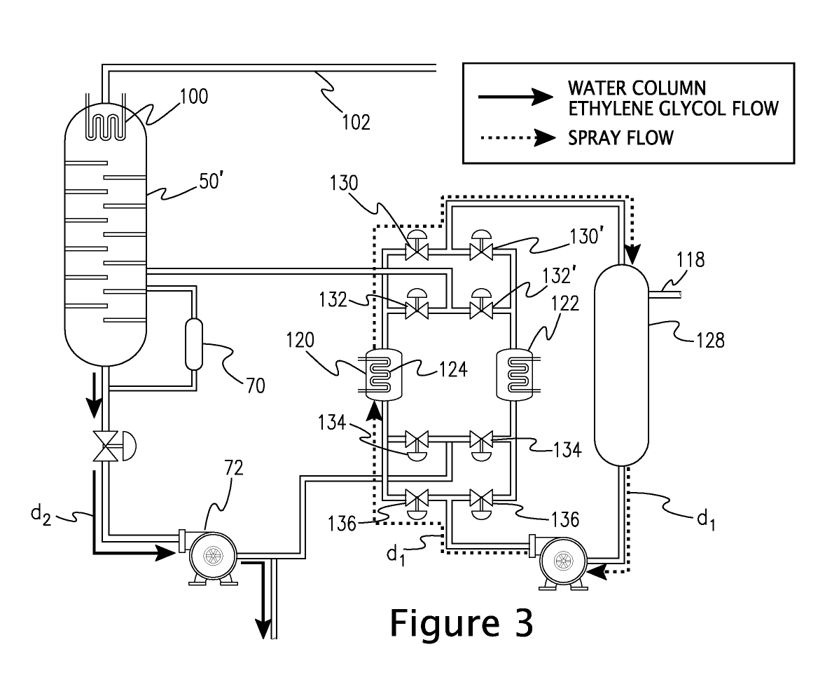

With reference to FIGS. 2 and 3, a refinement of the present invention that includes a plurality of spray separators is provided. Ethylene glycol and/or other low boiling compounds from pre-polymer reactor 26, polycondensation reactor 28, and polycondensation reactor 30 are directed respectively to spray separator systems 110, 112, 114. Waste liquid collected from spray separator systems 110, 112, 114 is subsequently directed to water separator system 48′. Each of spray separator systems 110, 112, 114 is of a similar general design.

FIG. 3 provides an idealized schematic for spray separator systems 110, 112, 114. For clarity, the spray separator of FIG. 3 will be referred to as spray separator 110 with the understanding that spray separator systems 112 and 114 are of the same general construction. An ethylene glycol-containing vapor composition is introduced into spray separator 110 via conduit 118. Spray separator 110 includes heat exchangers 120, 122, which remove heat from spray separator 110 thereby assisting in condensation of the ethylene-glycol containing vapor. Heat exchangers 120, 122 typically include tubes 124, 126 through which heat exchange fluids pass. Liquid circulates from column 128 through heat exchanger 120 or heat exchanger 122. The selection of which heat exchanger will be used is accomplished by the appropriate setting of valves 130, 130′, 132, 132′, 134, 134′, 136, 136′. FIG. 3 depicts the scenario in which liquid circulates through heat exchanger 120 along direction d₁. Also shown are users receiving recaptured ethylene glycol and other useful organics along direction d₂ via pump 72. Circulation of the fluid is assisted by pump 140.

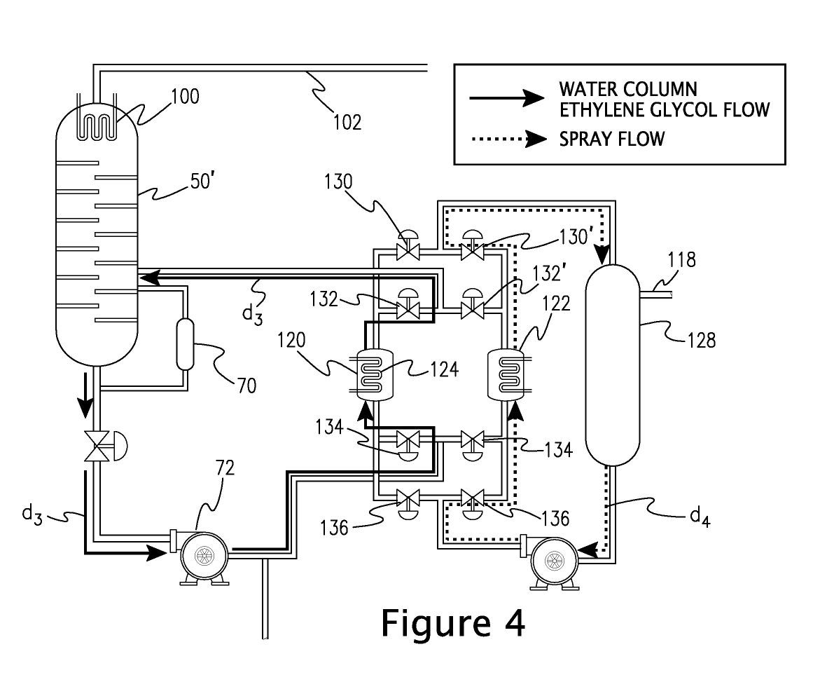

With reference to FIG. 4, a schematic illustrating the cleaning of a heat exchanger without producing wastewater is provided. After a period of time heat exchangers 120, 122 generally foul with solids as material precipitates on the inside walls and on tubes 124, 126. In the present variation, tubes 124, 126 and the interior walls of heat exchangers 120, 122 are cleaned when necessary by dissolving the solids in hot ethylene glycol. In this refinement, valves 130, 130′, 132, 132′, 134, 134′, 136, 136′ are set so that liquid circulates through heat exchanger 122. In the configuration depicted in FIG. 4, heat exchanger 120 is contacted with a composition comprising hot ethylene glycol derived from water separation column 50′ such that deposits on heat exchanger 120 are removed. The direction of the hot ethylene glycol is given as d₃. Such deposits are optionally recycled back in one or more stages of polymer-forming section 12. For example, the dissolved solids are fed back to water separation column 50′ or to the paste tank in order to recover the raw materials contained in the solids. Advantageously, this cleaning is performed with heat exchanger 120 in an assembled state (i.e., without disassembly). In a refinement of the present variation, the hot ethylene glycol comes in at a temperature from 100° C. to 250° C. In another refinement of the present variation the hot ethylene glycol comes in at a temperature from 180° C. to 210° C. The method of the present embodiment is useful for treating the wastewater from any chemical reactor that expels ethylene glycol in it wastewater.

With reference to FIG. 2, an additional variation of the present invention for removing or reducing the generation of wastewater in a polyester-manufacturing plant is provided. In this variation, polyester-manufacturing plant 10′ that includes polymer-forming section 12 and waste treatment section 14 enclosed with a roof 140 and walls 142, 144 to prevent rainwater from being contaminated with any organic chemical present in the polyester-manufacturing plant. In a variation of the present invention, components of polymer-forming section 12 and waste treatment section 14 that contain organics that may otherwise be contacted with rainwater are enclosed with a roof 140 and walls 142, 144 to prevent rainwater.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of reducing wastewater in a polyester-manufacturing plant that includes one or more chemical reactors and a water separation column in fluid communication with the one or more chemical reactors, the method comprising:
providing an ethylene glycol-containing composition from at least one of the chemical reactors to the water separation column, the water separation column separating a portion of ethylene glycol from the ethylene glycol-containing composition;
maintaining the water separation column within a predetermined temperature range such that any acetaldehyde present in the water separation column is maintained substantially in a vapor state;
removing a waste-vapor mixture comprising one or more organic compounds from the water separation column; and
combusting the waste-vapor mixture.

2. The method of claim 1 wherein ethylene glycol-containing composition from at least one of the chemical reactors further comprises water.

3. The method of claim 1 wherein the waste-vapor mixture comprises an organic component selected from the group consisting of ethylene glycol, acetaldehyde, p-dioxane, 1,3 methyl dioxolane, and combinations thereof.

4. The method of claim 1 wherein the separation column is maintained at a temperature from about 90° C. to about 220° C.

5. The method of claim 1 wherein a condenser is located within or proximate to the water separation column, the condenser being controlled in a manner such that the separation column is within the predetermined temperature range.

6. The method of claim 1 wherein the polyester-forming plant further comprises one or more spray condenser systems that receive ethylene glycol from the one or more chemical reactors.

7. The method of claim 1 wherein the one or more chemical reactors comprise an esterification reactor.

8. The method of claim 1 wherein the polyester-manufacturing plant is a PET-manufacturing plant.

9. The method of claim 1 wherein the waste-vapor mixture is removed from the separation column at a temperature from 80° C. to 130° C.

10. The method of claim 1 wherein the waste-vapor mixture is combusted in at least one heat source utilizing a fuel as a combustion source.

11. The method of claim 10 wherein the waste-vapor mixture combined with the fuel prior to being combusted.

12. The method of claim 1 further comprising enclosing the polyester-manufacturing plant with a roof and walls such that rainwater is prevented from being contaminated with any organic chemical present in the polyester-manufacturing plant.

13. A method of reducing wastewater in a polyester-manufacturing plant that includes one or more chemical reactors, a spray condenser system having a heat exchanger, and a water separation column in fluid communication with the one or more chemical reactors, the method comprising:
providing a wastewater composition comprising water and ethylene glycol from at least one of the chemical reactors to the water separation column, the water separation column separating a portion of the ethylene glycol from the water;
maintaining the separation column within a predetermined temperature range such that any acetaldehyde in the wastewater composition present in the column is maintained substantially in a vapor state;
removing a waste vapor mixture comprising water and one or more organic compounds from the separation column;
combusting the waste vapor mixture;
contacting the heat exchanger with a hot ethylene glycol composition such that deposits on the heat exchanger are removed, at least a portion of the hot ethylene glycol being derived from the water separation column; and
enclosing the polyester-manufacturing plant with a roof and walls such that rainwater is prevented from being contaminated with any organic chemical present in the polyester-manufacturing plant.

14. The method of claim 13 wherein the vapor mixture comprises an organic component selected from the group consisting of ethylene glycol, acetaldehyde, p-dioxane, 1,3 methyl dioxolane, and combinations thereof.

15. The method of claim 13 wherein the separation column is maintained at a temperature from about 90° C. to about 220° C.

16. The method of claim 13 wherein a condenser is positioned at the top of the water separation column, the condenser being controlled in a manner such that the separation column is within the predetermined temperature range.

17. The method of claim 13 wherein the heat exchanger is maintained in an assembled state during treatment with the ethylene glycol composition.

18. The method of claim 13 further comprising recycling the deposits back into at least one chemical reactor.

19. The method of claim 18 wherein the chemical reactor is an esterification reactor.

20. The method of claim 13 wherein the polyester-manufacturing plant is a PET-manufacturing plant.

21. The method of claim 13 wherein the waste-vapor mixture is removed from the separation column at a temperature from 80° C. to 130° C.

22. A polyester-manufacturing plant with reduced wastewater emission, the polyester-manufacturing plant comprising:
polymer-forming section having one or more chemical reactors;
a waste treatment section having a water separation column, the waste treatment section receiving ethylene glycol-containing fluids from the polymer-forming section, the water separation column system maintained within a predetermined temperature range such that any acetaldehyde in the water separation column is maintained substantially in a vapor state; and
a combustion device for combusting the waste vapor mixture.

23. The polyester-manufacturing plant of claim 22 further comprising a condenser located within or proximate to the water separation column, the condenser being controlled in a manner such that the separation column is within the predetermined temperature range.

24. The polyester-manufacturing plant of claim 22 further comprising a spray condenser system that receives ethylene glycol from the one or more chemical reactors.

25. The polyester-manufacturing plant of claim 24 wherein the spray condenser system further comprises a heat exchanger, the heat exchanger being in fluid communication with the water separation column such that the heat exchanger is contacted with a hot ethylene glycol composition such that deposits on the heat exchanger are removed.
